(19) United States
(12) Patent Application Publication
(10) Pub. No.: US 2014/0267759 A1
(43) Pub. Date: Sep. 18, 2014

(54) ESTIMATION OF FINE STRUCTURE WITHIN PIXELS IN SATELLITE IMAGERY

(71) Applicant: DIGITALGLOBE, INC., (US)

(72) Inventor: VICTOR H. LEONARD, BRIGHTON, CO (US)

(73) Assignee: DIGITALGLOBE, INC., LONGMONT, CO (US)

(21) Appl. No.: 13/844,493

(22) Filed: Mar. 15, 2013

(51) Int. Cl. H04N 5/33

(52) U.S. Cl. CPC H04N 5/33
USPC 348/164

(57) ABSTRACT

Techniques for synthesizing finer resolution image pixels and estimations of most likely endmembers and their abundances within relatively coarse resolution image pixels by using relatively fine resolution nearly collinear and nearly coincident panchromatic and multispectral data in the estimation of mixing endmembers, their abundances and their locations within native-scale coarse resolution imagery.

### BACKGROUND

The use of satellite-based and aerial-based imagery is popular among government and commercial entities. More and more, satellite imagery includes multispectral imagery where a plurality of discrete wavelength bands are used to collect images. In some cases, the various bands may have pixels of different size as discussed below.

The physics of imaging in the Short Wave Infrared (SWIR) (1100 to 3000 nanometers) from low earth orbit or high aerial altitude can necessitate certain technical and economic trades. In general, there is much less insolation (a measure of solar radiation energy received on a given surface area and recorded during a given time) in the SWIR than in the visible and Near Infrared (VNIR). So a common engineering solution is to settle for coarser pixel instantaneous field of view (IFOV) and to use (expensive) cooling systems to achieve adequate sensor performance. On WorldView-3 (WV3), a satellite to be launched in 2014 by DigitalGlobe, Inc., the SWIR multi-spectral (MS) instrument has native pixels with a ground sample distance (GSD) of 3.75 m at nadir. This is in contrast to the native 31 cm GSD VNIR panchromatic and 1.24 m GSD VNIR MS pixels at nadir.

There are many objects of interest that are small compared to the size of a native WV3 SWIR pixel. For example, a one meter square object is less than 7% of the size of WV3 SWIR pixel at nadir. Whether or not a given small object can be detected in WV3 SWIR pixels is dependent in part on the spectral contrast of the object relative to everything else contributing to the energy in a given SWIR pixel band. For example, if the small object is very bright in the SWIR and the background is very dark in the SWIR, then it is possible that the small object will increase the SWIR pixel that it is in by just enough that the SWIR pixel will be slightly brighter than the surrounding SWIR pixels that do not have similar bright contributors.

The challenge is that the natural variability of background materials in the SWIR wavelength range can easily mask the presence of a small object. There may also be many objects and materials of various sizes mixed in a given SWIR pixel. The spectral reflectance signature of a given material in a given state is referred to as an endmember. The fraction of the net signature contributed by a given endmember is referred to as the abundance. The net reflectance in each SWIR band is the sum of the products of each included endmember's signature with its abundance in that pixel.

### SUMMARY

Disclosed herein is a method of creating relatively higher resolution images from relatively lower native resolution images. The method includes obtaining images of a first resolution in a first spectral band; obtaining images of a second resolution in a second spectral band, wherein the second resolution is higher than the first resolution; and using information from the images of the second resolution in the second spectral band to synthesize a higher resolution than the first resolution in the images of the first spectral band.

The first spectral band may be in the SWIR wavelength range. The second spectral band may be in the VNIR wavelength range. The synthesis may occur by creating subpixels in the images of the first spectral band.

### BRIEF DESCRIPTION OF THE DRAWINGS

The disclosure herein is described with reference to the following drawings, wherein like reference numbers denote substantially similar elements:

FIG. 1 is a graph showing the hyper-spectral signature of five common ground materials.

FIG. 2 is an illustration of how the pixel synthesis occurs.

FIG. 3 is a flow diagram of the algorithm.

FIG. 4 is a diagram of a satellite obtaining images of the Earth's surface and sending them to a ground station for processing.

### DETAILED DESCRIPTION

While the embodiments disclosed herein are susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives of embodiments of the invention as defined by the claims. The disclosure is described with reference to the drawings, wherein like reference numbers denote substantially similar elements.

FIG. 4 shows a platform 20, such as a satellite, sensing light coming thereto from the direction of a target 22. The image sensor in the satellite or aerial vehicle measures the radiance (light energy) received at the sensor. The image sensor may collect radiant energy in a plurality of spectral bands, including various spectral bands in the VNIR and SWIR and other ranges, as well as one or more panchromatic bands. The platform 20 can communicate with a ground station 26 to send image data thereto. The ground station 26 may perform various processing (with computer systems, not shown) and/or storage of the image data and/or it may send the image data to other locations for processing and/or storage.

Taught herein are techniques that provide a capability to generate finer resolution SWIR image pixels and estimations of most likely endmembers and their abundances within comparatively coarser-scale SWIR pixels to enable broader area coverage at a finer effective SWIR resolution in a faster and more efficient manner.

At a high level, this invention synthesizes finer resolution SWIR imagery pixels and estimate the most likely endmembers and their abundances within relatively coarse resolution SWIR imagery pixels by using relatively fine resolution nearly collinear and nearly coincident VNIR panchromatic and multispectral data in the estimation of mixing endmembers, their abundances and their locations within native-scale SWIR imagery. The synthesized finer scale SWIR image pixels are normalized band by band using the ratio of a given native SWIR band pixel value divided by the sum of the nine synthesized fine-scale SWIR image pixel band values that contributed to that given SWIR band pixel value. The result is synthesized SWIR imagery at the spatial resolution of the native VNIR MS imagery.

The process uses abduction of the SWIR components of endmembers that were identified in the finer scale VNIR pixels that were collected in a nearly collinear and nearly coincident fashion. FIG. 1 shows the sixteen WV3 bands and their relation to hyperspectral signatures of five common materials. Note that the for the shown “green vegetation” endmember (the second from the bottom in the smallest wavelengths shown), the signature in the VNIR (i.e., spectrum covered by bands 1 thru 8) is correlated with the signature in the SWIR (i.e., spectrum covered by bands 9 thru 16). The “built up” endmember being the top one in the smallest wavelengths shown, the “np-vegetation” (non-photosynthetically-active vegetation) endmember being the middle one in the smallest wavelengths, the “bare soil” endmember being the second one from the top in the smallest wavelengths, and the “water” endmember being the bottom one in the smallest wavelengths.

There can be more pronounced variations within the SWIR range for a given endmember as compared to the VNIR range caused by physiological, transient, geometric and illumination conditions. For this reason, the master endmember signature library contains common variations for a given endmember along with their corresponding bi-directional distribution function (BRDF).

Nearly collinear imaging between the SWIR and VNIR imaging minimizes the errors that could be caused by different imaging perspectives. Nearly coincident (in time) imaging minimizes errors caused by changes in object state and changes in illumination conditions.

FIG. 2 describes the essence of synthesizing finer-scale SWIR MS imagery using coarser-scale SWIR MS imagery and finer-scale VNIR panchromatic and MS imagery. The left-most image shows the ground truth where a square patch of yellow grass is surrounded on three sides by green grass and on a fourth side by brown soil. The upper-most image shows the native VNIR MS pixels showing a column of green pixels on the left side, a column of grayish-brown pixels on the right side, and a middle column with a yellow pixel in the center and a pair of washed-out green pixels above and below. The lower-most image shows the native SWIR MS pixel (of lower resolution than the VNIR MS) in which the pixel is another shade of washed-out green. The two native pixel arrangements are combined to reach the Endmember Classification Matrix, which can be used to generate the “Synthesized SWIR MS pixels” image on the right-most side of FIG. 2. It shows a left-hand column of light green, a right-hand column of brown, and a center column with a yellow pixel in the middle and brownish-green pixels above and below.

FIG. 3 shows a very high level data flow diagram of the inputs, outputs and process flow. The general process details are described more fully in the following paragraphs.

The process starts with an original WV3 image with a WV3 panchromatic band at its native resolution, eight WV3 VNIR MS bands at their native resolution, and eight WV3 SWIR MS bands at their native resolution. Each of the seventeen bands is converted to absolute reflectance to compensate for atmospheric effects. Each of the seventeen bands is spatially registered to each other.

Each VNIR MS pixel in the entire scene is unmixed using a Master Spectral Library to obtain the best solution of endmember signatures from the library and their abundances given BRDF parameters, entropy textures from both panchromatic and eight VNIR MS bands and other factors. Entropy texture is used to reduce/resolve spectral ambiguities of some endmember classes. Other factors may include multi-pixel spatial cues and predicted state based on multiple observations and/or independent insights and models of reality.

The initial set of sub-pixel endmember solutions (i.e., endmember and corresponding abundance) for each VNIR MS pixel are stored as a temporary Initial Endmember Classification Matrix at the native VNIR MS spatial resolution (e.g., 1.24 m GSD at nadir) for the entire image. That classification matrix is then used to make a temporary First Synthetic SWIR image composed of estimated SWIR reflectance values for each SWIR band, but at the native VNIR MS spatial resolution. The First Synthetic SWIR Image pixels are then normalized band-by-band using the ratio of the native resolution SWIR band pixel value divided by the sum of the nine finer-scale synthesized SWIR image pixels that are aligned with that native resolution SWIR band pixel as shown in FIG. 2.

It is possible that the normalization process will make non-linear changes to the SWIR signatures of each pixel in the First Synthetic SWIR Image. So, for that reason a final pass is made on the First Synthetic SWIR Image to unmix it, but this time using both VNIR and SWIR pixels in the process. This results in a Final Endmember Classification Matrix. A Final Synthetic SWIR image is then made using the Final Endmember Classification Matrix to synthesize new SWIR pixels at the native VNIR GSD, which are then balanced using the native SWIR pixels as before.

The process ends with two new products: 1) a new WV3 image in absolute reflectance with a WV3 panchromatic band at its native resolution, eight WV3 VNIR MS bands at their native resolution, and eight WV3 SWIR MS bands at the native WV3 VNIR MS bands resolution, and 2) an endmember classification matrix with four primary endmembers per pixel with their respective abundances.

While the embodiments of the invention have been illustrated and described in detail in the drawings and foregoing description, such illustration and description are to be considered as examples and not restrictive in character. For example, certain embodiments described hereinabove may be combinable with other described embodiments and/or arranged in other ways (e.g., process elements may be performed in other sequences). Accordingly, it should be understood that only example embodiments and variants thereof have been shown and described.

We claim:

1. A method of creating relatively higher resolution images from relatively lower native resolution images, comprising:
obtaining images of a first resolution in a first spectral band;
obtaining images of a second resolution in a second spectral band, wherein the second resolution is higher than the first resolution; and
using information from the images of the second resolution in the second spectral band to synthesize a higher resolution than the first resolution in the images of the first spectral band.

2. A method as defined in claim 1, wherein the first spectral band is in the SWIR wavelength range.

3. A method as defined in claim 1, wherein the second spectral band is in the VNIR wavelength range.

4. A method as defined in claim 1, wherein the synthesis occurs by creating subpixels in the images of the first spectral band.
